(19) United States
(12) Patent Application Publication
(10) Pub. No.: US 2007/0145700 A1
(43) Pub. Date: Jun. 28, 2007

(54) METHOD AND APPARATUS FOR PORTABLE CONTAINER WITH INTEGRATED SEAT AND STABILIZATION MECHANISM

(76) Inventors: Richard Ambrose, Washington, DC (US); Eric M. Fresh, Stamford, CT (US); Kevin Bruce Gibbs, New York, NY (US); Emmanuel Addai, Dumfries, VA (US); Abdullah Nasser Aldawood, Arlington, VA (US); Shahed Amanullah, Austin, TX (US)

Correspondence Address: BELL, BOYD, & LLOYD LLP, P.O. BOX 1135, CHICAGO, IL, 60690, US

(21) Appl. No.: 11/550,285

(22) Filed: Oct. 17, 2006

Related U.S. Application Data
(60) Provisional application No. 60/727,488, filed on Oct. 17, 2005.

(51) Int. Cl. B62B 1/00

(52) U.S. Cl. 280/47.26

(57) ABSTRACT

A stabilized container is provided. The stabilized container includes a container, a portion of which is adapted to be a seat. The stabilized container also includes a stabilization device configured to stabilize the container. The stabilization device can include a frame. The stabilization device can also include a platform flexibly coupled to the frame at one or more locations. The portion adapted to be the seat can be coupled to the platform, and a free end of the platform can move relative to the frame in response to an amount of weight present on the portion. The container can include one or more wheels configured to contact a floor surface in a first orientation. The stabilization device can also include a skid configured to support the container in a second orientation in which the wheels are out of contact with the floor surface.

### RELATED APPLICATIONS

This non-provisional patent application claims priority to and the benefit of U.S. Provisional Patent Application Ser. No. 60/727,488, filed Oct. 17, 2005, the entire contents of which are incorporated herein.

### BACKGROUND

Portable containers such as luggage, backpacks, tool boxes, tackle boxes and golf club bags are frequently used to transport contents to locations where seating is unavailable, inconvenient or limited. For example, a traveler may have a suitcase in a long, slow-moving airport security, ticketing or check-in line. Such a weary traveler may be tempted to sit on one of his portable containers. However, typical portable containers are ill suited for being sat upon. First, the tops of portable containers are not designed to comfortably accommodate a user who wishes to sit on them. Second, the container may not be able to support the weight of someone sitting upon it. As a result, the container and/or its contents may be damaged. Further, the container may tip, roll or slide, causing the person sitting on it to fall and possibly be injured. Also, it is typically not comfortable to sit upon a typical container.

### SUMMARY

A stabilized container is provided. The stabilized container includes a container, a portion of which is adapted to be a seat. The stabilized container also includes a stabilization device configured to stabilize the container. The stabilization device can include a frame. The stabilization device can also include a platform flexibly coupled to the frame at one or more locations. The portion adapted to be the seat can be coupled to the platform, and a free end of the platform can move relative to the frame in response to an amount of weight present on the portion. The stabilization device can include a guide member that couples a free end of the platform to the frame. The container can include one or more wheels configured to contact a floor surface in a first orientation. The stabilization device can also include a skid configured to support the container in a second orientation in which the wheels are out of contact with the floor surface. The wheels can be retractable into the container such that an outer portion of the container rests on a floor surface when the wheels are retracted. The wheels can be coupled to the container by a spring retraction device configured to cause the wheels to automatically retract into the container if a threshold amount of weight is placed on the portion adapted to be the seat. The container can include a power source configured to provide power to an electronic device. The power source can be a rechargeable battery. The electronic device can be a laptop. The power source can be configured to supply power to the laptop when the laptop is placed in a pocket of the container.

A portable container is also provided. The container includes a shell, an opening in the shell providing access to a storage compartment, a seat disposed on the shell, and a support structure configured to substantially maintain a shape of the shell if a user sits on the seat. The shell can include a top portion and a base portion, the top portion being smaller than the base portion, and the seat being disposed on the top portion. The container can also include a power source operable to provide power to an electronic device. The power source can be a rechargeable battery. The electronic device can be a laptop computer. The power source can be configured to supply power to the electronic device when the electronic device is placed in the storage compartment.

An attachable seat is also provided. The seat includes a seat portion and a securing device configured to secure the seat portion to a piece of luggage. The seat can be padded and conformed into a chair or saddle-like contour for sitting in various positions. The seat can be located on the top or side of the luggage. The seat portion can include a recessed portion configured to receive a top portion of the piece of luggage. The securing device can be a strap configured to at least partly encircle the piece of luggage. The seat can alternatively be integrated into the structural frame of the container. The seat can have an embedded handle by which the container can be lifted, carried, or moved. The seat can have permanent or removable covers.

Additional features and advantages are described herein, and will be apparent from, the following Detailed Description and the figures.

### BRIEF DESCRIPTION OF THE FIGURES

FIG. 1 is a diagram of a portable container with a seat in accordance with one embodiment.

FIG. 2A is a diagram of a locking stabilizing device for a portable container in an unlocked position in accordance with one embodiment.

FIG. 2B is a diagram of a locking stabilizing device for a portable container in a locked position in accordance with one embodiment.

FIG. 3 is a diagram of a portable container showing one location of a locking mechanism in accordance with one embodiment.

FIG. 4 is a diagram of a portable container which has stabilizing skids in accordance with one embodiment.

FIG. 5 is a diagram of a portable container which has stabilizing skids in a tilted position in accordance with one embodiment.

FIG. 6 is a diagram of a portable container having a seat and a stabilizing leg in a retracted position in accordance with one embodiment.

FIG. 7 is a diagram of a portable container having a seat and a stabilizing leg in a stabilizing position in accordance with one embodiment.

FIG. 8 is a diagram of a container that resembles a backpack in accordance with one embodiment.

FIG. 9 is a diagram of a container adapted to serve as a tacklebox in accordance with one embodiment.

FIG. 10 is a diagram of a backpack-style container adapted for use by students in accordance with one embodiment.

FIG. 11 is a diagram of a container adapted to serve as a golf bag in accordance with one embodiment.

FIG. 12 is a diagram of a container adapted to serve as a toolbox in accordance with one embodiment.

FIG. 13 is a diagram of a container adapted for use by executives in accordance with one embodiment.

FIG. 14A is perspective view of a portable container with an integrated recessed seat in accordance with one embodiment.

FIG. 14B is side view of a portable container with an integrated recessed seat in accordance with one embodiment.

FIG. 14C is frontal view of a portable container with an integrated recessed seat in accordance with one embodiment.

FIG. 15A is perspective view of a portable container with an integrated saddle seat in accordance with one embodiment.

FIG. 15B is side view of a portable container with an integrated saddle seat in accordance with one embodiment.

FIG. 15C is frontal view of a portable container with an integrated saddle seat in accordance with one embodiment.

FIG. 16A is perspective view of a portable container with a narrow top and wide base in accordance with one embodiment.

FIG. 16B is side view of a portable container with a narrow top and wide base in accordance with one embodiment.

FIG. 16C is frontal view of a portable container with a narrow top and wide base in accordance with one embodiment.

FIG. 17A is perspective view of a portable container with a narrow top and wide base and straps in accordance with one embodiment.

FIG. 17B is side view of a portable container with a narrow top and wide base and straps in accordance with one embodiment.

FIG. 17C is frontal view of a portable container with a narrow top and wide base and straps in accordance with one embodiment.

FIG. 18A is front and side view of a seat in accordance with one embodiment.

FIG. 18B is front and side view of another seat in accordance with one embodiment.

FIG. 18C is front and side view of another seat in accordance with one embodiment.

FIG. 18D is front and side view of another seat in accordance with one embodiment.

FIG. 18E is front and side view of another seat in accordance with one embodiment.

FIG. 19 is perspective view four seat covers in accordance with one embodiment.

FIG. 20A is perspective view of a portable container with a laptop pocket in accordance with one embodiment.

FIG. 20B is side view of a portable container with a laptop pocket in accordance with one embodiment.

FIG. 20C is frontal view of a portable container with a laptop pocket in accordance with one embodiment.

FIG. 21A is perspective view of a strap-on seat in accordance with one embodiment.

FIG. 21B is side view of a strap-on seat in accordance with one embodiment.

FIG. 21C is frontal view of a strap-on seat in accordance with one embodiment.

FIG. 22A is frontal view of a rigid container with a latch in accordance with one embodiment.

FIG. 22B is side view of a rigid container with a latch in accordance with one embodiment.

FIG. 23A is frontal view of a duffle bag container in accordance with one embodiment.

FIG. 23B is side view of a duffle bag container in accordance with one embodiment.

FIG. 24A is perspective view of a frame with a suspension system in accordance with one embodiment.

FIG. 24B is side view of a portion of a frame with a suspension system in accordance with one embodiment.

FIG. 24C is perspective view of another frame with a suspension system in accordance with one embodiment.

FIG. 24D is side view of a portion of another frame with a suspension system in accordance with one embodiment.

FIG. 24E is side view of another frame with a suspension system in accordance with one embodiment.

FIG. 24F is perspective view of another frame with a suspension system in accordance with one embodiment.

FIG. 25A is a perspective view of a portable container with a retractable seat in accordance with one embodiment.

FIG. 25B is a side view of a portable container with a retractable seat in accordance with one embodiment.

FIG. 25C is a top view of a portable container with a retractable seat in which a user is pulling the retractable seat towards an extended position in accordance with one embodiment.

FIG. 25D is a top view of a portable container with a retractable seat in a retracted position in accordance with one embodiment.

### DETAILED DESCRIPTION

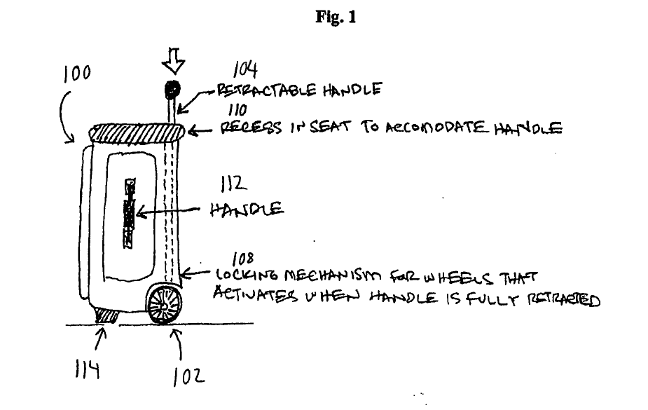

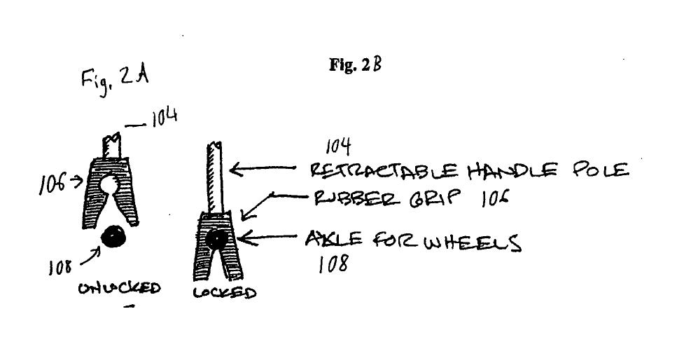

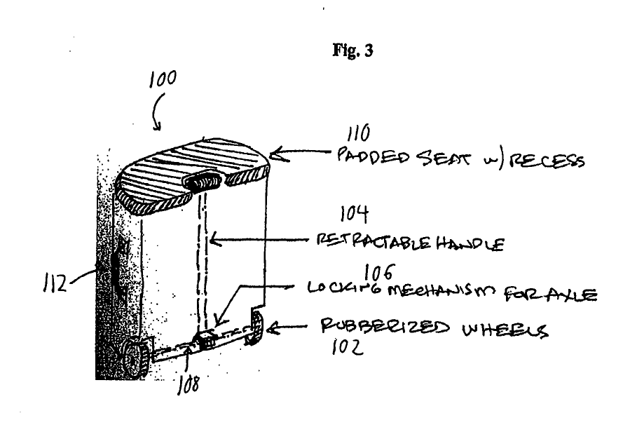

Various embodiments are shown in FIGS. 1-25D. In one embodiment, the container can be used to alleviate some of the strains of frequent travel, such as standing in ticketing lines and taxi lines and sitting on floors or leaning on walls while waiting to board a plane or bus; however, the container can be used in any suitable situation.

One function of the container can be to transport belongings and contents during travel; however, the container can transport any suitable items. The container can resemble and/or act as luggage, a backpack, a carrying case or any other suitable portable container design. The container can have an upper surface that is adapted to function as a seat for the user; however, any suitable portion or no portion of the contain can be adapted to function as a seat. The container preferably includes a rigid frame or hard shell; however, the container is not required to have a rigid frame or a hard shell. The container preferably includes a stable base; however, the container is not required to have a stable base. Further, the container preferably includes a handle, which may be extensible or telescopic; however, the container is not required to have a handle or the handle can be of any suitable type.

The container can include a base including one or more wheels. The wheels can be configured to be locked or otherwise restricted in motion. The wheels can be retractable, such that they no longer protrude from the container or the base of the container; however, the wheels are not required to be retractable or the wheels can be retractable in any suitable manner. The base can include rails and/or legs configured such that the wheels do not touch the ground or other rolling surface when the user positions the container for sitting; however, the rails and/or legs can be configured in any suitable manner. The rails and/or legs can be fixed or extendible from the base or from the sides of the container, such as by unfolding or by extending from a compartment or can be arranged in any other suitable manner. The wheels can be coupled to springs, or the wheel axles or any other suitable portion of the portable container can be coupled to springs that allow the wheels to turn and the container to be rolled when in transport, but that compress or contract causing the wheels to move at least partly into the base of the container when the user sits on the upper surface such that the bag does not roll and/or is stable for sitting.

The portable container can include additional features for the convenience of the user and/or to increase stability, portability, and/or usefulness. The container can include a pouch or receiving sleeve for a laptop or portable computer or any other suitable item. The pouch or sleeve can include a connection to a power source, so that a laptop or other electronic device, when inserted into the pouch and/or connected to the power source, is supplied with power to operate or recharge a battery. In one embodiment, the power source includes a rechargeable battery and is coupled to a power connector which can couple to another power source (such as a typical power outlet) to recharge the battery and/or supply power directly to the laptop computer or other electrical device.

In other embodiments, the container can include one or more internal and/or external pockets for receiving contents and for easy organization and storage. The container can include a zipper or other closure along at least a portion of the perimeter of the upper surface, which may join the upper surface and the sides of the container, allowing access to at least a portion of the interior of the container. The container can alternatively include a zipper or other closure along at least a portion of at least one side of the container, which may join the upper surface and the side or the side and at least one other side, allowing access to at least a portion of the interior of the container. The container can include a zipper or other closure along any suitable portion.

The container can include hard materials, such as plastics or metals, and/or soft metals, such as canvas, leather, corduroy, duralite, microfiber, nylon, polyester, and rayon, and/or any other suitable material. The frame or shell can include any suitable material, including plastics and metals. The sides, upper surface, and base of the container can be joined to at least a portion of the frame or shell or may comprises at least a portion of the frame or shell or can be arranged in any other suitable manner.

In various embodiments, the container can be configured in the form of a backpack with an integrated seat in the upper surface and an internal frame made from aluminum tubing. The container can include a wide base at the bottom in order to provide stability when the user sits upon the upper surface. Preferably, at least one edge of the base and potentially one side of the container are crescent shaped or otherwise designed to fit comfortably and securely around the back of the user; however the container can be arranged in any suitable manner. The container can also include two wheels as part of the base and a telescoping handle.

In other embodiments, a container can resemble a carrying case which serves one function as luggage or a backpack. The container can also include a functioning seat integrated into the basic design as a secondary function. Some users of these portable containers may consider the primary function of the portable containers as a carrying case for travel, sports, school, or other personal items, but preferably will be able to use the device, with little or no modification and with little or no assembly, as a stable seat that can support any suitable amount of weight (e.g., at least 300 lbs, at least 500 lbs, etc.). The container can resemble, in one of its many forms, a typical carry-on suitcase or backpack, although the container will preferably contain rigid internal frames or hard-body shells, a seat on top, and a stable base.

A portable container can be configured to resemble any suitable container type such as a carrying case, luggage, or backpack. The portable container preferably includes an integrated seat. One possible function of the container is as a carrying case, for example, for travel, sports, school, or other personal items. Another possible function of the container, with little or no modification and with little or no assembly, is as a stable seat. The container can resemble a typical carrying case, suitcase, or backpack. The container can include at least one of a rigid internal frame and a hard-body shell, a seat, and a stable base. The container can include one or more wheels on its base and an extendible handle.

A portable container can look like a travel suitcase design to serve as a seat when the container is in the upright position. The side that faces up when the container is in an upright position preferably has a padded seat integrated into the face of the side. The seat may or may not be padded, and may or may not be contoured for comfort and oriented for use in either direction. The container's shape is preferably reinforced by an aluminum frame capable of withstanding the weight of an adult sitting on it. The container can include a retractable handle, wheels and a two handles, one on the top side and another on the side. The exterior fabric of the container can be any suitable material including microfiber, nylon, leathers and suede.

As shown in FIGS. 1-3, in one embodiment, the container 100 can be at least partly stabilized by locking the wheels 102. When a telescoping handle 104 is retracted into the container 100, a rubber grip 106 at the base of the handle 104 preferably latches on to the axel 108, preventing the wheels 102 from turning; however, a retracted telescopic handle 104 or other element can lock or impede movement of the wheels 102 in any suitable manner. Preferably, the locked wheels 102 enhance the stability of the container 100 making it sturdier to sit on. The container 100 preferably also includes a padded and/or formed seat 110; however a padded or formed seat 110 is not required. The seat 110 is preferably configured so that the handle can rise past or through the seat 110. The container 110 can also optionally have a handle 112 on one or more surfaces. Further, the container 112 preferably includes one or more legs or skids 114 arranged such that when the container 110 rests on the wheels 102 and the legs 114, the seat 110 is substantially parallel to the surface on which the container 100 rests.

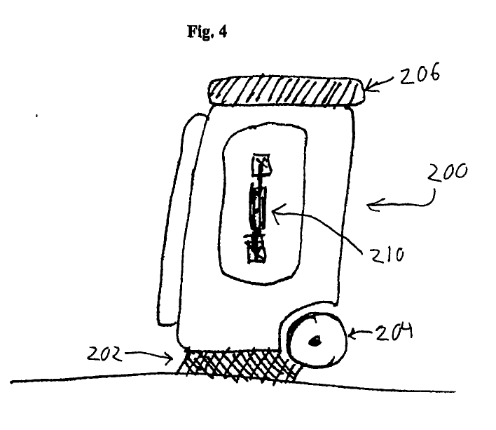

As shown in FIGS. 4-5, in one embodiment, similar to the above embodiment, the container 200 preferably includes a seat 206, a telescoping handle 208 and one or more other handles 210. The container 200 can include one or more large skids 202 on the base of the base of the container 200. Preferably, when the container 200 is in the upright position, the wheels 204 are slightly suspended off the ground and the container 200 rests solely on the skids 202. In order to roll the container 200, the container 200 needs to be tilted towards the wheels 204, enabling the wheels 204 to touch the ground.

The wheels (or axels) of a container can rest on springs. When the container is sat on, the wheels will retract at least partly into the container, causing the container to rest on its bottom side. If no one is sitting on container, the springs push the wheels out enabling the user to roll the container.

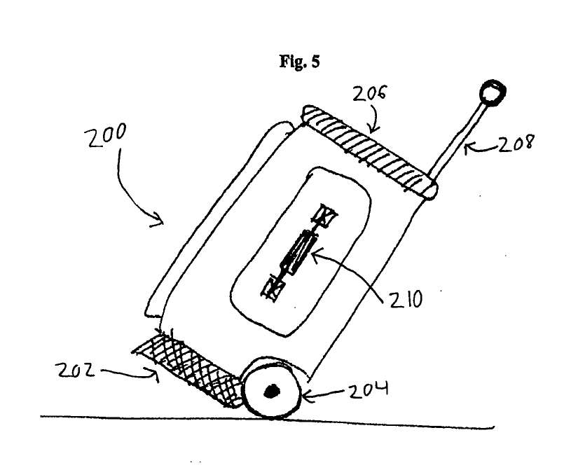

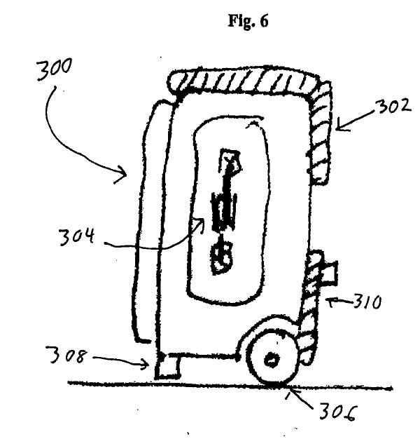

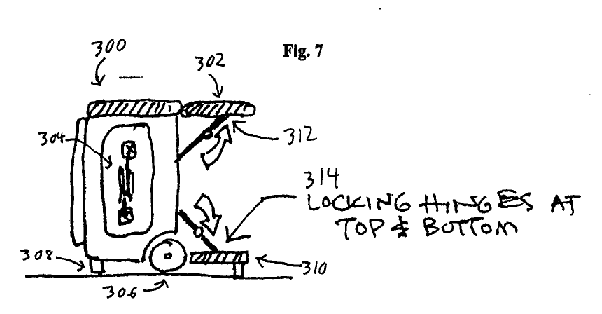

As shown in FIGS. 6-7, in one embodiment, similar to the above embodiment, the container 300 preferably includes one or more handles 304, wheels 306, and one or more legs or skids 308. The container 200 can include a seat or portion of a seat 302 can be flipped out from a side (e.g., the back side) of the container 300. Preferably, if the seat 302 is pulled out to a seating enabling position as shown in FIG. 7, an additional stabilizing leg 310 also automatically folds out. However, in other embodiments, the additional leg 310 folds out independently of the seat 302 or is absent.

Preferably, the seat 302 is supported by aluminum hinges 312 that lock when the seat 302 is unfolded to the seating enabling position; however, the seat 302 can be supported in any suitable manner and the hinges 312 can be any suitable material. Preferably, hinges 314 stabilize the leg 310 in the unfolded position as shown in FIG. 7, and the hinges 314 also lock, similar to hinges 312; however, the leg 310 can be stabilized in any suitable manner. The additional leg 310 widens the base of the container 300, resulting in a more stable seating platform in at least one axis (e.g., the axis running through the leg 308, wheel 306 and additional leg 310). Individuals tend to be more stable in a left-right axis when sitting than they are in a front-back axis. To accommodate for this difference in human stability, in one embodiment, the seat 302 is contoured or otherwise configured to encourage a user to sit on the seat 302 such that the user's front-back axis is substantially parallel to axis made more stable by the additional leg 310.

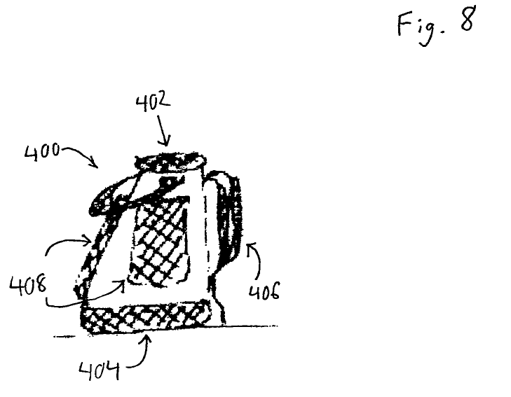

As shown in FIG. 8, in one embodiment, the container 400 can resemble a backpack with rigid internal frames so as to provide support for the seat 402 located on the top of the pack. Preferably, waterproof material (e.g., gortex) covers the bottom 404 and runs six inches (or any suitable distance) up the sides of the container so that when the container is set down in the upright position in a moist environment, the contents in the container will not get wet. However, the waterproof material is not required, and water control can be implemented in any suitable manner, including but not limited to lining an interior portion or pocket surface with a waterproof or water resistant material.

Preferably, the container 400 in this embodiment includes straps 406 and several mesh pockets 408. Additionally, the container 400 preferably has an expandable vinyl outer shell; however, the exterior of the container 400 can have any suitable properties and can include any suitable material. Further, the container 400 is preferably lightweight and suitable for transporting sports goods (e.g., large enough to transport a basketball or other sports equipment).

As shown in FIG. 9, in one embodiment, a portable container 500 is configured to help fishermen transport fishing tackle and potentially the day's catch. Preferably, the container 500 includes wheels 502, one or more legs, 504 a telescoping handle 506 and one or more retractable trays 508 to store tackle. Preferably, the top half of the container 500 includes a waterproof cooler 510 to carry the day's catch, bait, a picnic, drinks or any other suitable item. Alternatively, the container 500 can include a refrigeration device. In the upright position, the hinged top or a portion thereof of the container preferable serves as a seat 512. Preferably, the top forms a water-tight seal for the cooler 510 and can be removed to access the cooler 510; however, the top can be configured in any suitable manner and the cooler 508 can be accessed in any suitable manner. Further, the shell of the container 500 is preferably a rigid plastic; however, the shell can include any suitable material.

As shown in FIG. 10, in one embodiment, a portable container 600 can be configured to be useful for students of any age. The container 600 preferably includes a telescoping handle 602, wheels 604, one or more legs 606, a padded laptop sleeve 608 and straps 610 so that it can be carried as a backpack. The container can include an internal aluminum frame designed to support the seat 612 and a canvas outer shell; however the internal frame and outer shell can each include any suitable material. When the bag is in the upright position, the seat 612 can be integrated into the top side of the container or a portion thereof.

The laptop sleeve 608 can include or be coupled to a power source. The power source can include one or more plugs, adaptors, induction devices or any other devices suitable for supplying power to a laptop or other electronic device placed in or coupled to the sleeve 608. Preferably, the power source is a rechargeable battery which can be coupled to another power supply (e.g., a wall outlet) to recharge; however, the power supply can be any suitable power supply. In one embodiment, a generator is included to recharge the battery. The generator can generate energy as a result of the turning of wheels 604, the motion of the container 600 when moved or worn similar to batteryless no-wind watches, the action of a fuel cell, a solar panel, a wind turbine or any other suitable energy generating mechanism.

As shown in FIG. 11, in one embodiment, a portable container 700 can resemble a golf bag with a seat 702 integrated into its design. The container 700 preferably appears like a typical golf bag, and the container 700 can include wheels 704 in order to make the easy to transport on and off the golf course and legs 706 to increase the stability of the container in a seating enabling position. Preferably, the seat 702 protrudes from the main bag and is supported by an aluminum frame; however, the seat 702 can be supported in any other suitable manner. Under the seat, there is preferably storage space 708 accessible through a zipper or any other suitable accessing device. In one embodiment, the container 700 includes a ball washer. The ball washer can be of the crank or plunger variety or any other suitable washing device.

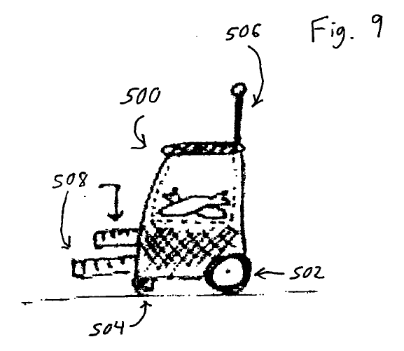

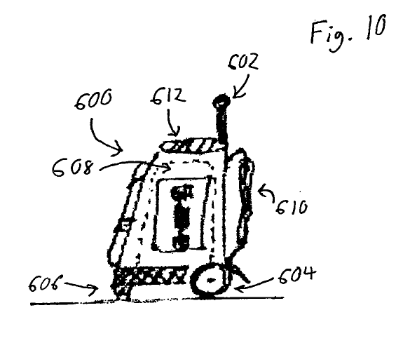

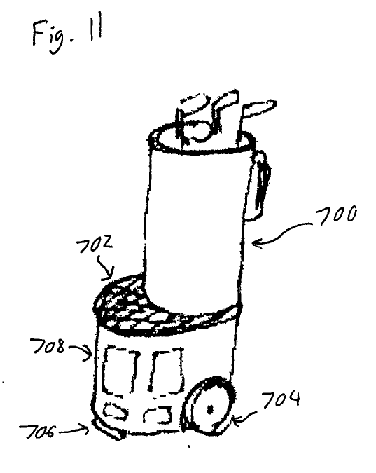

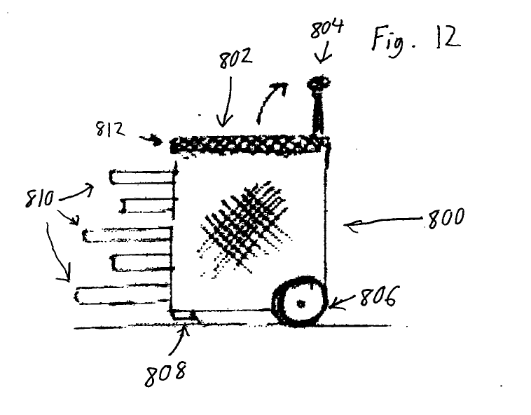

As shown in FIG. 12, in one embodiment, a portable container 800 can resemble a rolling toolbox with an integrated seat 802 on the topside. Preferably, the container 800 includes a retractable handle 804 and wheels 806 enabling the user to roll the container 800 easily. Similar to other embodiment, the container 800 also has one or more legs 808. Preferably, the container 800 includes one or more trays 810 that can be pulled out from the front side of the container and in which tools can be stored and/or organized. Further, the seat 802 is preferably hingedly attached to the container 800 so that the seat 802 can be raised to provide access to an additional equipment tray 812.

Preferably, the container 800 includes a power source that can include one or more plugs, adaptors, induction devices or any other devices suitable for supplying power to corded power tool or a rechargeable batter for a cordless power tool. Preferably, the power source is a rechargeable battery which can be coupled to another power supply (e.g., a wall outlet) to recharge; however, the power supply can be any suitable power supply. In one embodiment, a generator is included to recharge the battery. The generator can generate energy as a result of the turning of wheels 806, the motion of the container 800 when moved similar to batteryless no-wind watches, the action of a fuel cell, a solar panel, a wind turbine or any other suitable energy generating mechanism.

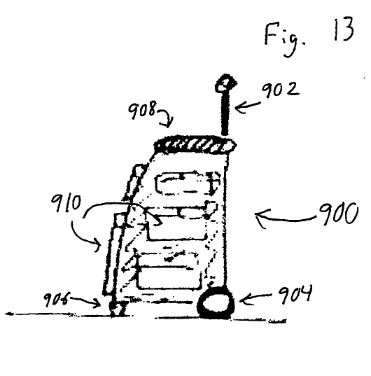

As shown in FIG. 13, in one embodiment, a portable container 900 can project a classy image with its exterior being made of black or tan leather; however, the exterior can include any suitable material and can have any suitable color or pattern. Preferably, the container 900 includes a telescoping handle 902, wheels 904, one or more legs or skids 906, and strong additional handle on one or more sides to make it easy to transport. The interior preferably includes a padded sleeve for laptops and a rigid frame to support a seat 908. The seat 908 is preferably integrated into the topside of the bag when the container is in an upright position. The container 900 also preferably includes several other pockets 910 on the outside of the main carrying space. Preferably, the dimensions of the container 900 are small enough so that it will enable the owner to carry the bag on an airplane as carry-on rather than checked luggage.

As shown in FIGS. 14A-C, in one embodiment, a portable container 1000 can have an integrated recessed seat 1002. The container also optionally includes a telescoping handle 1004, wheels 1006, legs 1008, one or more exterior pockets 1010, and an interior cavity accessibly by opening a front surface 1012. Preferably, the front surface 1012 is opened by unzipping three sides of the front surface 1012, preferably excluding the bottom side; however, the interior cavity can be accessible in any suitable manner.

Preferably, the seat 1002 is padded; however, the seat 1002 is not required to be padded. Further, the seat 1002 is preferably configured such that the top surface of the container 1000 slopes downward towards the portion of the container 1000 that is over the legs 1008 rather than the wheels 1006. As a result, the seat 1002 is provided with additional depth. Further, the seat 1002 guides the person sitting upon it to sit at approximately an area of the seat which provides for substantially optimal stability. For example, the user is guided to sit with more weight forward, over the legs 1008 instead of back over the wheels 1006. As a result, more of the user's weight is supported by the legs 1008 instead of the wheels 1006, making the container 1000 less likely to tip backwards or roll. In another embodiment, the seat 1002 is configured to cause a user to sit substantially over the center of gravity of the container 1000.

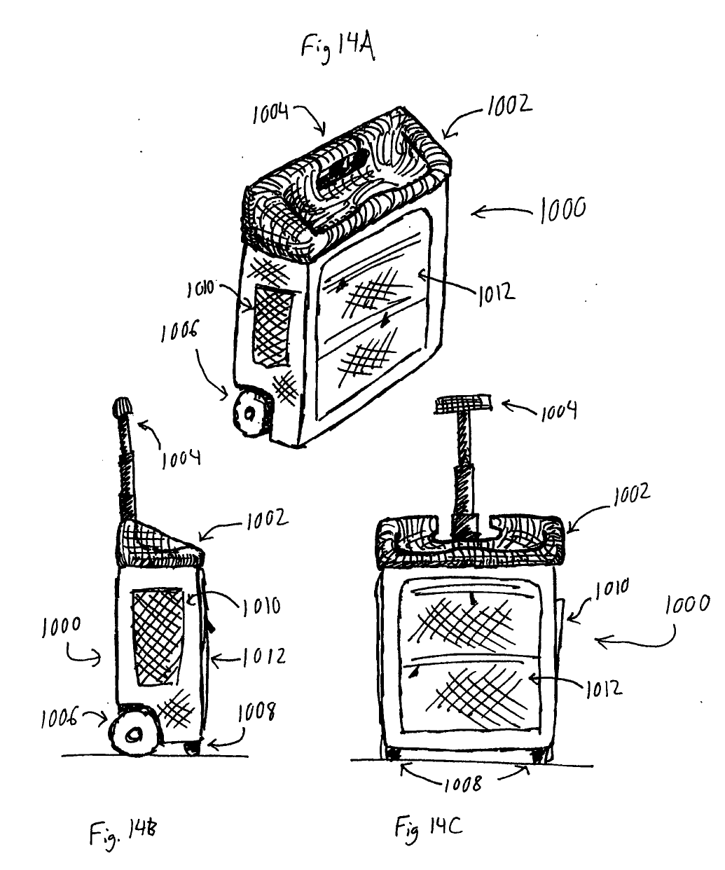

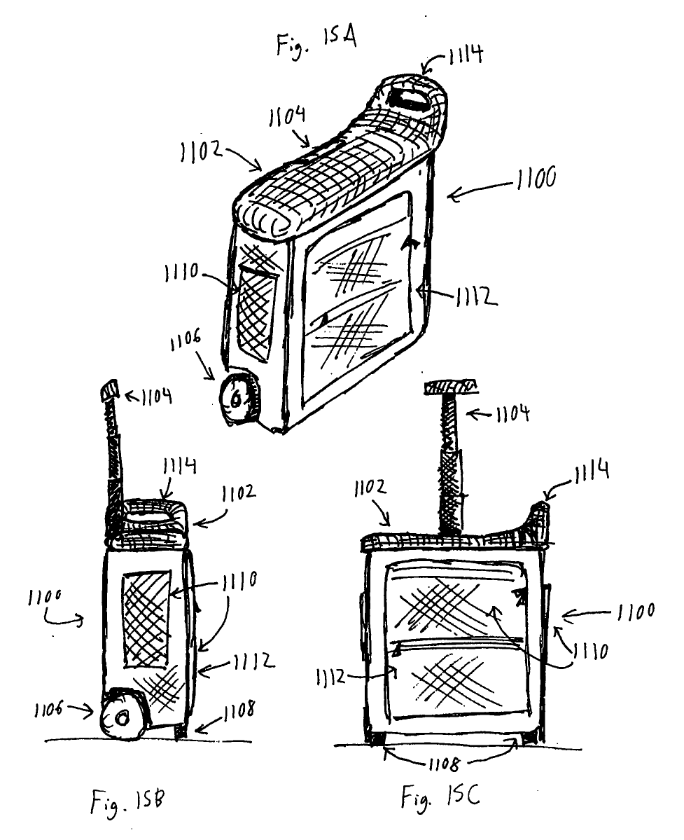

As shown in FIGS. 15A-C, in one embodiment, a portable container 1100 includes an integrated saddle seat 1102. The container also optionally includes a telescoping handle 1104, wheels 1106, legs 1108, one or more exterior pockets 1110, and an interior cavity accessibly by opening a front surface 1112. Preferably, the front surface 1112 is opened by unzipping three sides of the front surface 1112, preferably excluding the bottom side; however, the interior cavity can be accessible in any suitable manner.

The seat 1102 also preferably includes a handle portion 1114 and is configured to guide a user to sit facing a right or left side of the container 1100 instead of the front or the back. Further, the seat 1102 preferably covers the entire top surface of the container 1100, is padded and rounded with a depression substantially near the center, and has a raised back, making the seat 1102 similar to a bicycle seat. Further, the seat is preferably slightly sloped towards the front end. As a result, the user's least stable axis (forward and back) is aligned with the longer of the two dimensions of the container 1100 when in the seating enabling position. Consequently, the user's greater ability to stabilize in a left and right direction prevents the user from tipping the container 1100 in those directions and the container's greater stability along the user's front and back directions prevents the user from tipping the container 1100 in those directions.

As shown in FIGS. 16A-C, in one embodiment, a portable container 1200 has a wider base than top. Similar to other embodiments, the container 1200 optionally includes a telescoping handle 1204, wheels 1206, legs 1208, one or more exterior pockets 1210, and an interior cavity accessibly by opening a front surface 1212. Preferably, the front surface 1212 is opened by unzipping three sides of the front surface 1212, preferably excluding the bottom side; however, the interior cavity can be accessible in any suitable manner.

The seat 1202 is located at the top of the container 1200 and preferably extends beyond one or more sides of the container 1200. Preferably, the sides slope inwards from the base to the seat 1202. As a result, the seat is preferably located over the center of mass of the container 1200, increasing the stability of the container 1200.

As shown in FIGS. 17A-C, in one embodiment, a portable container 1300 similar to the one illustrated in FIGS. 16A-C, having a wider base than top, can also be a backpack. Accordingly, the container 1300 includes straps 1302. Preferably, the container 1300 includes padding on the side which will rest on the user's back. Further, the container 1300 optionally includes a waist strap to distribute some of the weight of the container 1300 to the user's hips rather than the shoulders and back. Preferably, the straps 1302 and waist strap, if any, can be retracted and/or stored in compartments of the container 1300.

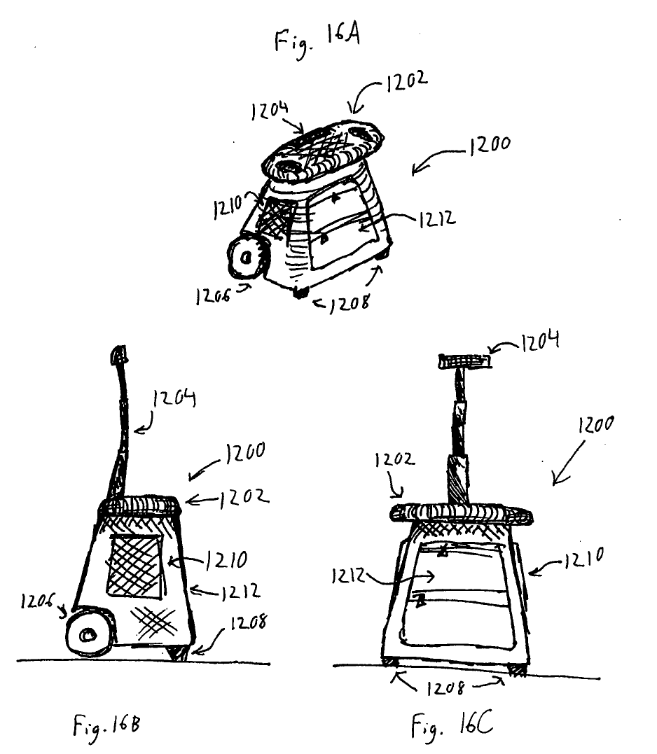

FIGS. 18A-E show different possible seat configurations for use in one or more embodiments. A saddle style seat 1400 encourages a sitter to sit long-wise on a container and use the sitter's legs to stabilize against left/right tipping. Another saddle style seat 1402 has a depression near the center, creating an appearance and functionality similar to that of a bicycle seat. A basic seat 1404 has a rectangular shape and a substantially flat seating surface. A recessed seat 1406 provides comfort and positions a sitter in a location configured to substantially optimize the stability of a container. The seat 1406 can have a sloped surface similar to the one described above. Alternatively, the seat 1408 can have a substantially flat top surface surrounding the recessed portion.

FIG. 19 shows four exemplary seat covers 1500. The seat covers 1500 are preferably at least partly elastic to cause the covers 1500 to fit tightly on a seat; however, the seat covers are not required to have any elasticity. Further, the covers 1500 preferably include a Velcro strip configured to attach to another Velcro strip on the container, thus securing the cover 1500 to the container; however, the covers 1500 can be secured to the containers in any suitable manner. The covers 1500 can include any suitable material and can have any suitable pattern or design, including flags, university or company, sports team, or government entity logos or other indicators, images of one or more individuals (e.g., a loved one, an enemy, or a liked or unliked celebrity).

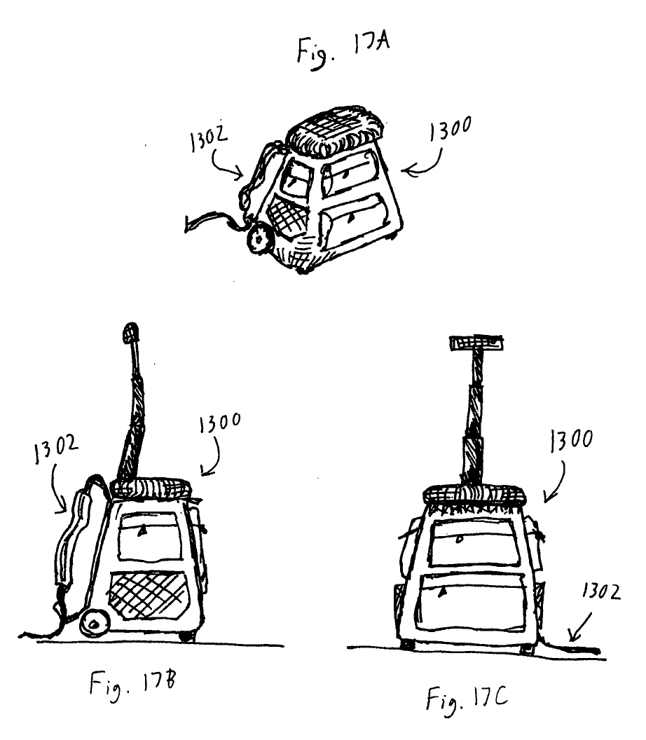

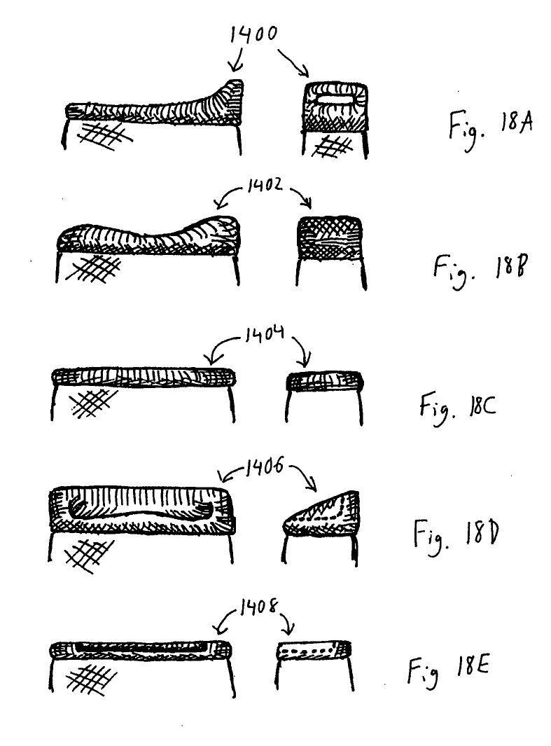

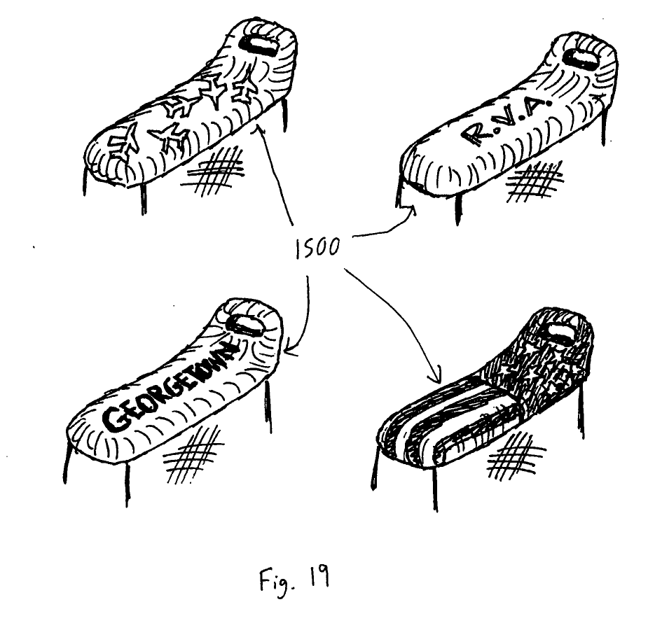

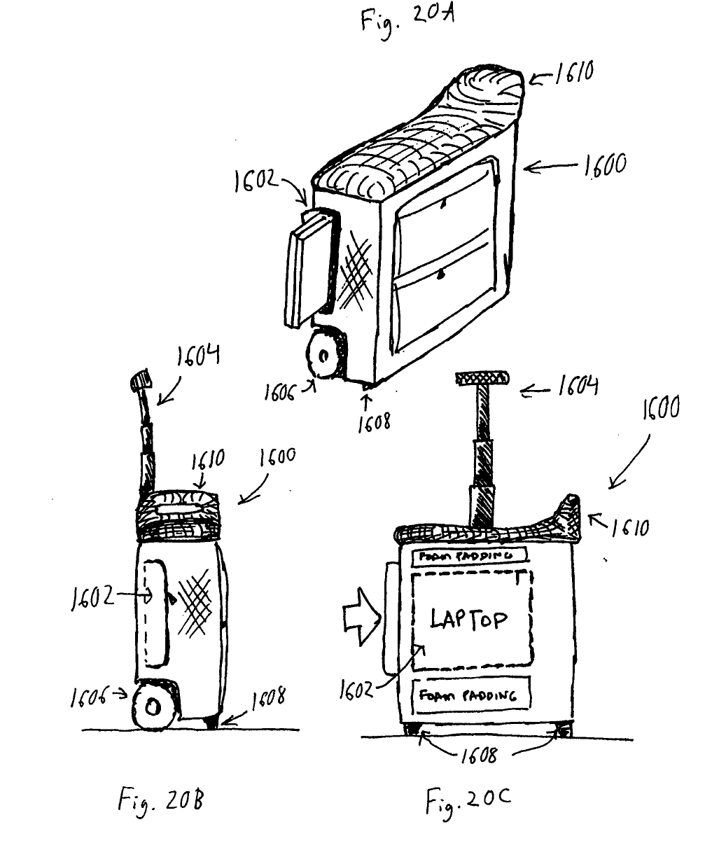

As shown in FIGS. 20A-C, in one embodiment, a portable container 1600 includes an isolated laptop storage pocket 1602. The pocket 1602 preferably has access from the side of the container 1600 and is accessibly by a zipper, Velcro or any other suitable opening and closing device. As a result, a user can access a laptop in the pocket 1602 or place a laptop in the pocket 1602 without the need to open the main compartment. The container 1600 also optionally includes a telescoping handle 1604, wheels 1606, legs 1608, a cup holder, and a seat 1610. The container 1600 preferably includes an internal aluminum frame designed to support the seat 1610; however the internal frame can include any suitable material. Further, the container 1600 preferably includes padding (e.g., a foam or gel pad) above and below the laptop to reduce the compressive forces that may be exerted on the laptop when the user sits on the seat 1610.

The pocket 1602 can include or be coupled to a power source. The power source can include one or more plugs, adaptors, induction devices or any other devices suitable for supplying power to a laptop or other electronic device placed in or coupled to the pocket 1602. Preferably, the power source is a rechargeable battery which can be coupled to another power supply (e.g., a wall outlet) to recharge; however, the power supply can be any suitable power supply. Preferably, the battery can be recharged while power is simultaneously supplied to the laptop (e.g., to operate the laptop or to recharge its battery). For example, a user can place the laptop in the pocket 1602 and plug the container into the wall to recharge both the container's rechargeable battery and the laptop's battery.

In another embodiment, the container 1600 includes a retractable platform upon which a laptop can rest while being operated. The platform is preferably located such that when a user is sitting as desired in the seat (i.e., sitting in a substantially optimal position for stability), the platform is substantially in front of the user. The platform can include a plug, cord, adapter or any other device suitable to couple the laptop to the container's 1600 power source.

In one embodiment, a generator is included to recharge the battery. The generator can generate energy as a result of the turning of wheels 1606, the motion of the container 1600 when moved or worn similar to batteryless no-wind watches, the action of a fuel cell or any other suitable energy generating mechanism.

In one embodiment, a device which provides vibration or massaging action to the seat 1610 is powered by the container's 1600 power source. The vibration provides additional comfort and relaxation to the user.

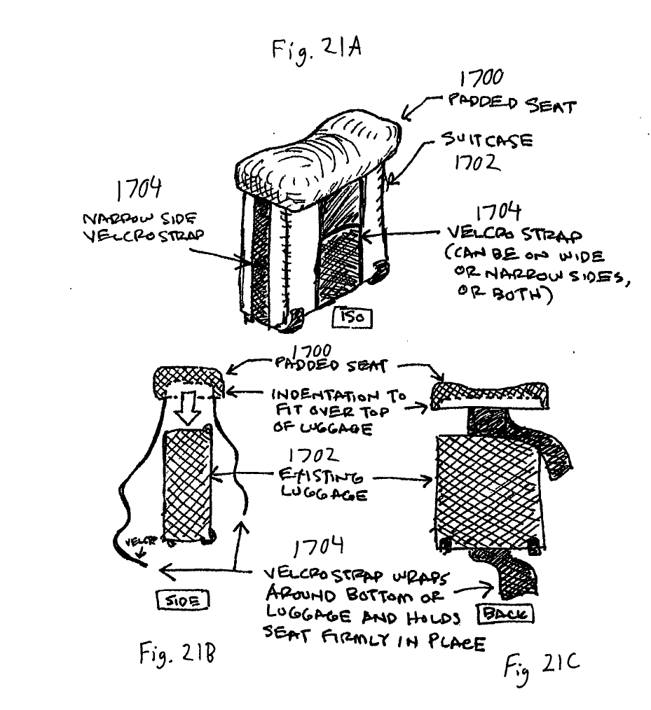

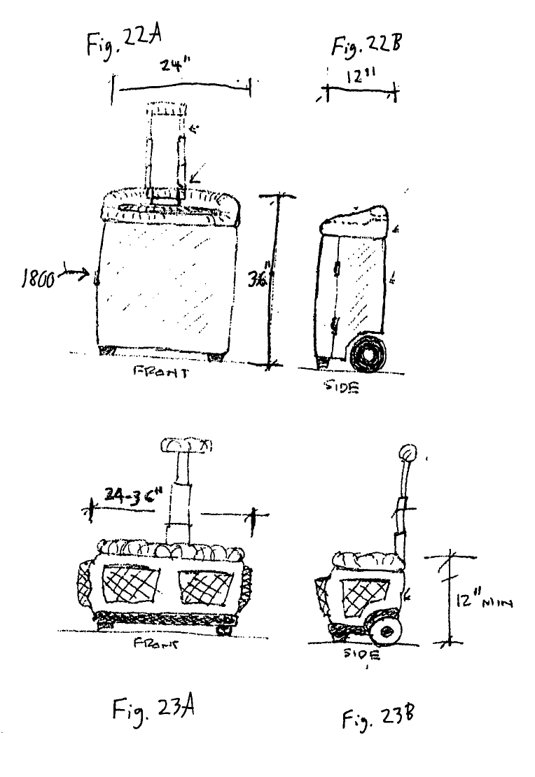

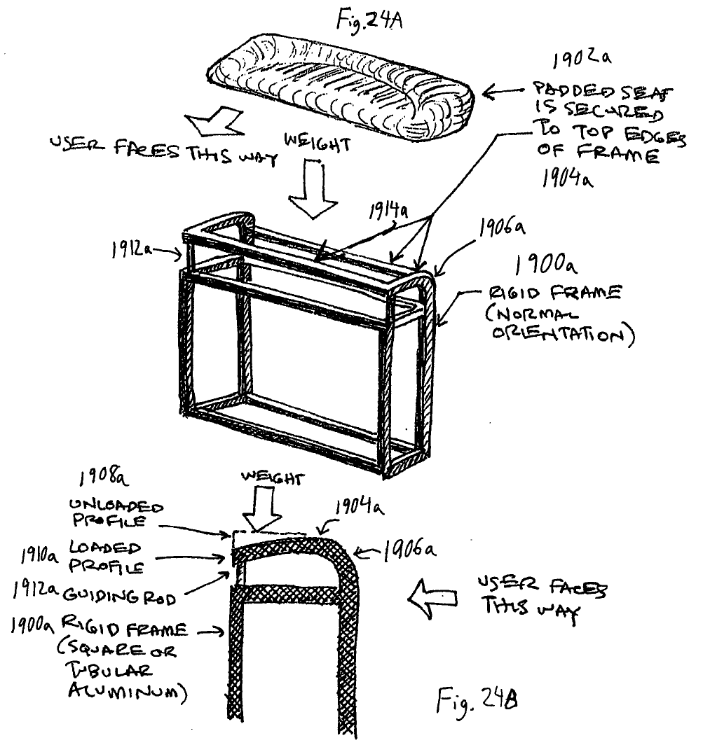

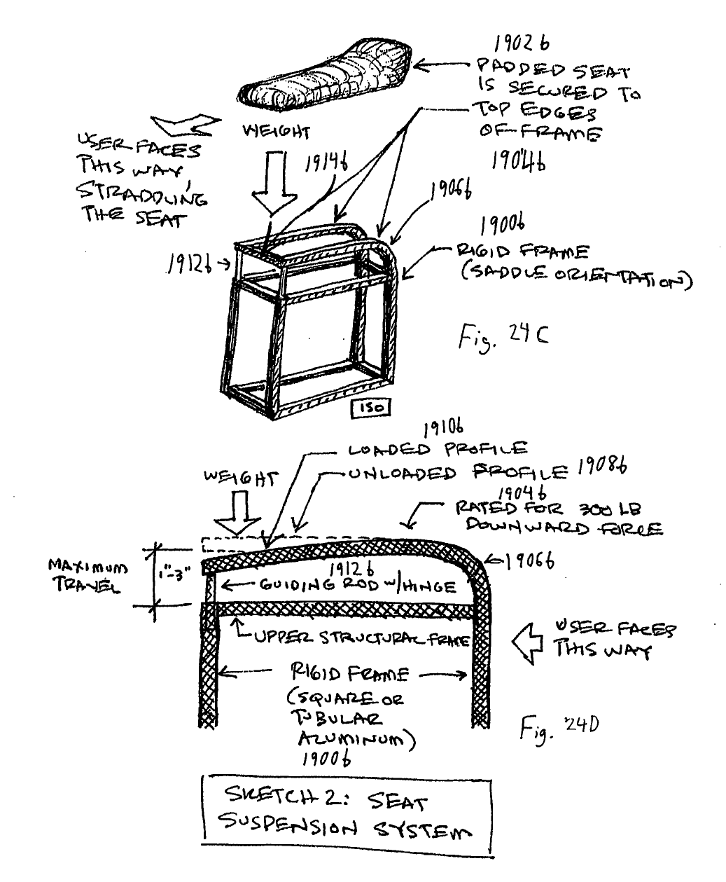

As shown in FIGS. 21A-C, in one embodiment, a seat 1700 is provided. The seat 1700 can be harnessed to a container 1702 to provide a user with the ability to sit comfortably on the container 1702. The seat 1700 can have any suitable design including those described in embodiment above, ones resembling a booster chair or seats with backs. The seat 1700 can include any suitable material, such as molded plastic or aluminum. The seat 1700 can also include any suitable cushioning such as gel, foam, or cotton. Further, the seat can have any suitable covering, such as a smooth fabric.

Preferably, the seat has a recessed area or compressible area into which a top portion of the container 1702 can be positioned. Preferably, the seat 1700 attaches to the container 1702 by a harness system including Velcro straps 1704; however, the seat 1700 can be attached to the container in any suitable manner such as hooks, clasps, metal teeth fasteners, snaps and buttons. The container 1702 may be designed to mate with the recess of the seat 1700; however, the seat 1700 can also be generically usable on pre-existing containers (e.g., by configuring the compressible area to accommodate more than one different size and shape of container).

In one embodiment, a collapsible or adjustable support frame is provided with the seat 1700. The frame can be positioned within the container 1702 to ensure the container 1702 does not collapse when a user sits on it. The height and width of the frame can be adjusted in any suitable manner, including a ratchet system or a strong twist system similar to those used in many camera tripods.

FIGS. 22A-B show an exemplary embodiment of a large suitcase having an embedded seat. This embodiment is similar to above embodiments and includes a latch 1800; however, a container can have any suitable closing or locking device or no such device. It should be appreciated that the dimensions of 12″×24″×36″ are exemplary only and other embodiments can have other dimensions. For example, the embodiment shown in FIGS. 23A-B is a sports dufflebag with an embedded seat having a height of 12″ and a width in the range of 24″ to 36″.

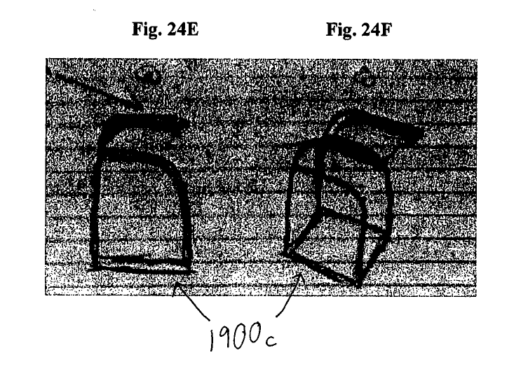

FIGS. 24A-F show three embodiments in which the frames 1900a, 1900b and 1900c include a suspension system. The suspension system both provided additional comfort to a user and causes the seat to tip forward when the user sits so that the user's weight is shifted towards the front of the container. As a result, the container is more stable to sit upon. The frame 1900a or 1900b is shown as including twelve rods connected to form a box frame; however, the frame can include any suitable number of rods, panels or other structures and form any suitable shape, for example that shown in frame 1900c, which has fewer rods than frames 1900a and 1900b and in which some of the rods are curved.

Preferably, two of the upright rods or members of the frame extend beyond the box and curve around so that the portion becomes substantially parallel to the top of the box. The seat 1902a or 1902b is placed upon this parallel portion 1904a or 1904b such that the user will sit facing away from the curve 1906a or 1906b of the upright members. Preferably, the curve 1906a or 1906b is flexible. As a result, portion 1904a or 1904b will rest in one position 1908a or 1908b when no one is sitting in the seat 1902a or 1902b, and a second, lower (e.g., one to three inches lower) position 1910a or 1910b when someone is sitting in the seat 1902a or 1902b. Thus, a sitter is leaned slightly forward, making the container more stable. The frame 1900a or 1900b preferably includes a compressible guide portion 1912a or 1912b which couples the end of the portion 1904a or 1904b (e.g., the free end) to the front upright members; however, such a guide portion is not required. The guide portion 1912a or 1912b can preferably help prevent the parallel portion 1904a or 1904b from moving too far in a downward or sideways direction. Further, the frame also preferably includes a cross bar 1914a or 1914b between the ends of the parallel portion 1904a or 1904b; however, such a cross bar is not required.

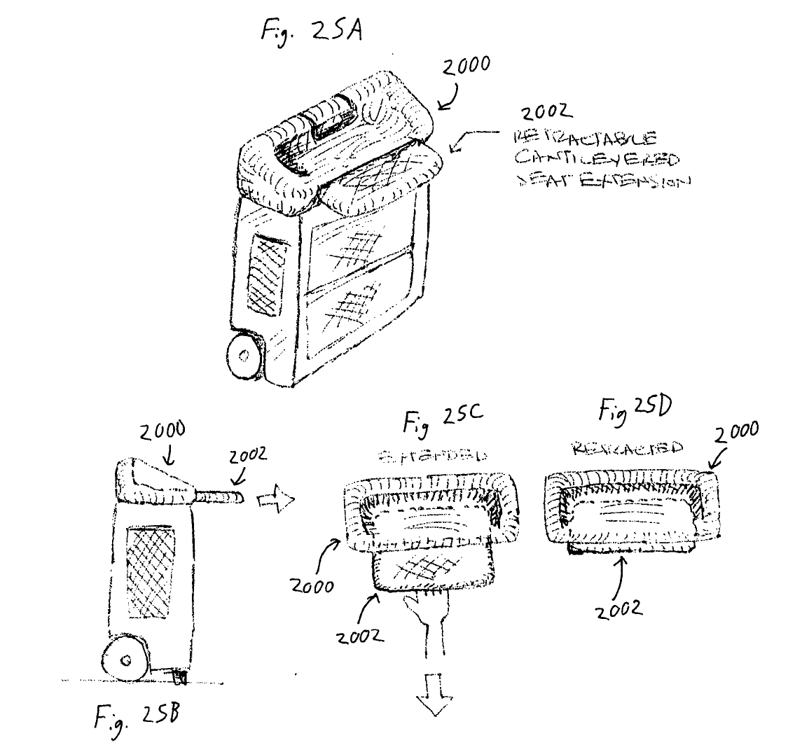

FIGS. 25A-D show a portable container having an extendible seat. The container 2000 is similar to one or more above described embodiments. The container includes a seat and an extendible seat portion 2002. Preferably, the extendible seat portion 2002 can retract into an opening or shelf in the container 2000 below the seat. Preferably, the seat portion 2002 is manually extended and/or retracted; however, the seat portion 2002 can be extended and/or retracted in any suitable manner utilizing any suitable device, including a spring mechanism or a latch/release mechanism. Preferably, the seat portion 2002 includes a stopping device which prevents the seat portion from being completely removed from the container 2000; however, in various embodiments, the seat portion 2002 can be completely removed from the container 2000.

It should be understood that various aspects of the embodiments described above can be used in or with other embodiments described above. It should also be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A stabilized container comprising:
a container, wherein a portion of the container is adapted to be a seat, the container being adapted to support a user when the user is seated in the seat; and
a stabilization device configured to stabilize the container.

2. The stabilized container of claim 1, wherein the stabilization device includes a frame.

3. The stabilized container of claim 2, wherein the stabilization device includes a platform flexibly coupled to the frame at one or more locations, wherein the portion adapted to be the seat is coupled to the platform, wherein a free end of the platform moves relative to the frame in response to an amount of weight present on the portion.

4. The stabilized container of claim 3, wherein the stabilization device includes a guide member, wherein the guide member couples a free end of the platform to the frame.

5. The stabilized container of claim 1, wherein the container includes one or more wheels, the wheels being configured to contact a floor surface in a first orientation, wherein the stabilization device includes a skid, the skid being configured to support the container in a second orientation in which the wheels are out of contact with the floor surface.

6. The stabilized container of claim 1, wherein the container includes one or more wheels, the wheels being retractable into the container such that an outer portion of the container rests on a floor surface when the wheels are retracted.

7. The stabilized container of claim 6, wherein wheels are coupled to the container by a spring retraction device configured to cause the wheels to automatically retract into the container if a threshold amount of weight is placed on the portion adapted to be the seat.

8. The stabilized container of claim 1, wherein the container includes a power source configured to provide power to an electronic device.

9. The stabilized container of claim 8, wherein the seat is adapted to position a user sitting in the seat in a substantially optimal position for stability of the container.

10. The stabilized container of claim 1, wherein the seat is adapted to position a user sitting in the seat substantially in the center of a top surface of the container.

11. The stabilized container of claim 10, wherein the power source is configured to supply power to the laptop when the laptop is placed in a pocket of the container.

12. A portable container comprising:
a shell;
an opening in the shell, the opening providing access to a storage compartment;
a seat disposed on the shell; and
a support structure configured to substantially maintain a shape of the shell if a user sits on the seat.

13. The portable container of claim 12, wherein the shell includes a top portion and a base portion, the top portion being smaller than the base portion, and the seat being disposed on the top portion.

14. The portable container of claim 12, further comprising:
a power source operable to provide power to an electronic device.

15. The portable container of claim 14, wherein the power source is a rechargeable battery.

16. The portable container of claim 14, wherein the electronic device is a laptop computer.

17. The portable container for claim 14, wherein the power source is configured to supply power to the electronic device when the electronic device is placed in the storage compartment.

18. An attachable seat comprising:
a seat portion; and
a securing device configured to secure the seat portion to a piece of luggage.

19. The attachable seat of claim 18, wherein the seat portion includes a recessed portion configured to receive a top portion of the piece of luggage.

20. The attachable seat of claim 18, wherein the securing device is a strap configured to at least partly encircle the piece of luggage.
